(19) United States
(12) Patent Application Publication
(10) Pub. No.: US 2003/0200170 A1
(43) Pub. Date: Oct. 23, 2003

(54) Free internet service provider backed by a credit card carrier - a new form of safe e-commerce method and system

(76) Inventor: Samuel Sergio Tenembaum, (US)

Correspondence Address: Samuel Sergio Tenembaum, c/o 34 East 67 Street, 2nd. Floor, New York, NY, 10021, US

(21) Appl. No.: 10/124,956

(22) Filed: Apr. 19, 2002

(51) Int. Cl. G06F 17/60

(52) U.S. Cl. 705/39

(57) ABSTRACT

The present invention deals with a new method of safe E-commerce, here referred to as “Free internet service provider backed by a credit card carrier—a new form of safe e-commerce method and system”. According to this method, Credit Card Carriers, in conjunction with free Internet Service Providers, offer a Safe Shopping Zone where the Cardholders can purchase products and services without giving away any sensitive information, neither to Merchants nor to any other third parties.

This application claims the benefit of U.S. Provisional Application No. 60/242,746 filed in the U.S. Patent and Trademark Office on Oct. 25, 2001; the entire contents of the aforementioned Provisional Application being hereby incorporated by reference.

### FIELD OF THE INVENTION

The present invention relates generally to a new kind of safe e-commerce method and system, and more particularly relates to a business method to implement such invention.

### BACKGROUND

E-Commerce is becoming increasingly popular thanks to its striking advantages over the traditional brick-and-mortar commerce. However, at the same time, E-Commerce has apparently intrinsic problems, most of them related to the perils of fraud which characterize online transactions.

Our invention is all about a new form of electronic online commerce, to be referred as “Free internet service provider backed by a credit card carrier—a new form of safe e-commerce method and system”.

According to our method, the Credit Card Carrier (such as Visa, Mastercard, American Express, or any new player) sets-up a free Internet Service Provider (ISP), either of its own, or in joint venture with an existing or newly created ISP. This free ISP will be offer its services, exclusively for the Cardholders of the said Credit Card Carrier.

Each and every time a Cardholder logs on to the Internet via the ISP in question, he/she is duly identified and he/she gains access to a specially designed Safe Shopping Zone where the Cardholder can purchase a wide variety of products and services, without fearing the risk of fraud.

This fraudless environment is guaranteed by the very structure of the business model. In fact, the Safe Shopping Zone ensures that the consumer remains absolutely anonymous to the Merchants. Whenever an order is placed, what really happens is that the Credit Card Carrier becomes the purchasing party vis a vis the Merchant, so that the latter does not get any identifying information pertaining to the end user who actually places the purchase.

The Credit Card Carrier in turn, identifies and keeps all the relevant information of each and every cardholder (such as name, shipping address, phone number, etc.) and takes care of physically channeling the order to the proper buyer, without the intervention of the Merchant.

In accordance to our invention, the main players will be:

1. The Credit Card Carrier.

2. The Free ISP (which could be the same as the Credit Card Carrier).

3. The Merchants.

4. The Cardholders (who also are the clients of the Free ISP).

### SUMMARY

Our invention features a number of benefits which could be outlined as follows:

1. Ultimate safety for the Cardholders. They don't have to divulge any personal information to the Merchants. They only convey the information to their trusted Credit Card Carrier (which anyway has this information).

2. Extra-flexibility for the Cardholders: Each cardholder will be able to access his/her ordering history and even place repeating orders with extreme simplicity.

3. Extra-business for the online Merchants: as they gain access to a wide clientele base which otherwise would be reluctant to engage in E-Commerce.

4. Extra-business for the Credit Card Carrier, for the same reason described above.

5. Extra-business for the ISP (if different from the Credit Card Carrier) as it can profit from merchants commissions as well as from online advertising.

### BRIEF DESCRIPTION OF THE DRAWINGS

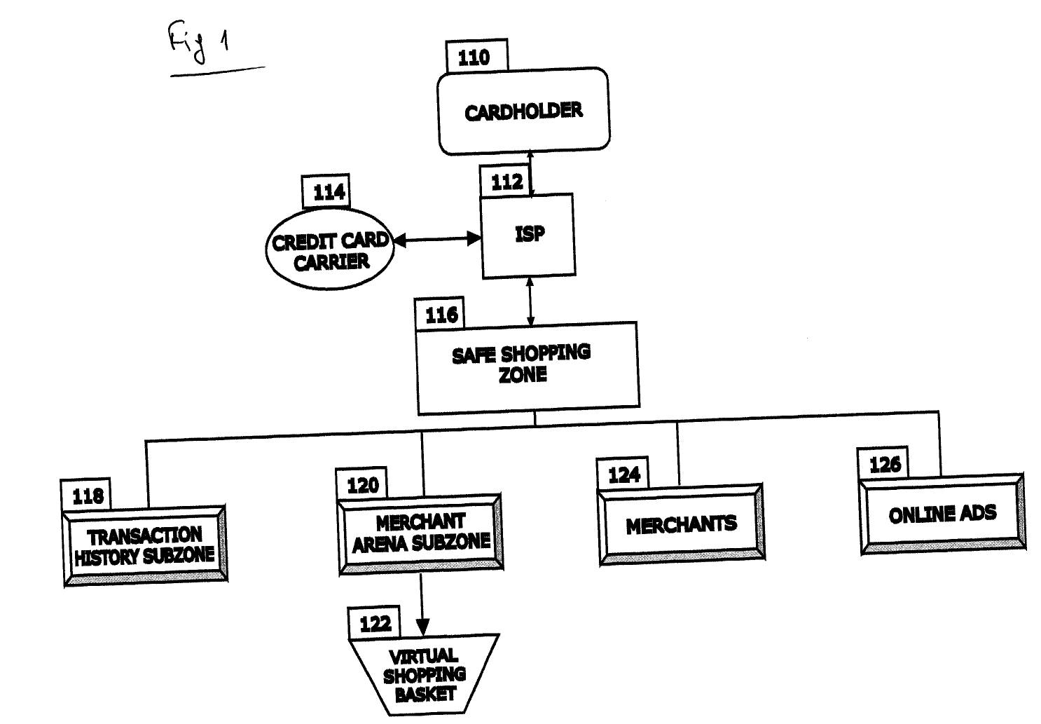

The foregoing brief description, as well as further objects, features and advantages of the present invention will be understood from the following detailed description of the presently preferred embodiment, with reference being made to the accompanying drawing in which FIG. 1 is a block diagram illustrating the business model for implementing this method. The main players are the Credit Card Carrier, the Free ISP, the online Merchants, the Cardholders and the Online Advertisers.

### DETAILED DESPCRIPTION

These and other aspects of the invention will now be described in greater detail in connection with a number of exemplary embodiments.

The present invention provides a method of conducting safe E-commerce in a secure and agile environment.

The method comprises the following steps:

The Cardholder 110 logs on to the Internet via his/her account with the Internet Service Provider ISP 112, which according to the preferred embodiment of this invention, offers free of charge access to the Cardholder 110.

Once online, the Cardholder 110 may opt to surf any Internet website, engage in e:mail exchange, enter chat rooms, etc., or he/she may also access the Safe Shopping Zone 116, exclusive for the Cardholders who signed-up with the Credit Card Carrier 114 for this service.

Once in the Safe Shopping Zone 116, The Cardholder 110 may log onto his/her personal Transaction History Subzone 118 that contains all the relevant information about his/her previous purchases or wish lists. The Transaction History Subzone 118 is build-up in such way that the Cardholder 110 is able to obtain intelligent cross-sections regarding his/her purchasing patterns or preferences.

If he/she is interested in purchasing products or services, the Cardholder may enter the Merchant Arena Subzone 120, in which, a great number of Merchants 120 will offer their products/services to the Cardholder.

During his/her visit to the Merchant Arena Subzone 120, the Cardholder 110 may fill-up his/her Virtual Shopping Basket 122 with any number of products/services, either form the same or from different Merchants 124. When proceeding to checkout, the Cardholder 110 sees in the screen a detailed and consolidated bill that will include full information on the items purchased, from what merchants, at what price and what are the delivery timetable for each one. Upon confirmation of the order, the Cardholder 110 does not need to enter any identifying personal details, such as name, billing address, shipping address, etc., because all those details are already stored in the computerized systems of the Credit Card Carrier 114.

The Credit Card Carrier 114 processes the order and passes on to the each Merchant 124 only the minimum relevant information to enable shipment of the product/services purchased by the Cardholder 110. Of course, this information does not include sensitive information, such as the Cardholder's 110 Credit Card Number or billing address, thus avoiding the possibility of fraud.

While in the Safe Shopping Zone 116, the Cardholders 110 are exposed to targeted, unsolicited or opt-in Online Advertising 126, such as Shoshkele (TM) animations or other forms of online ads.

What is claimed is:

1. A method featuring a new type of safe E-commerce environment, offered by a Credit Card Carrier, whereby Cardholders carry-out online purchases by means of accessing the Internet through especially assigned Internet Service Providers (ISP). While online, the Cardholder may conduct online purchases through a Safe Shopping Zone, without giving out to the Merchants any sensitive information liable to fraud.

2. The method of claim 1, wherein the Internet Service Provider (ISP) is the same entity as the Credit Card Carrier or is a wholly owned subsidiary of the latter.

3. The method of claim 1, wherein the Internet Service Provider (ISP) is a different entity than the Credit Card Carrier.

4. The method of claim 1, wherein the Internet Service Provider (ISP) offers free of charge access to the Cardholders.
